(19) United States
(12) Patent Application Publication
(10) Pub. No.: US 2005/0136182 A1
(43) Pub. Date: Jun. 23, 2005

(54) Method of folding and stacking scented paper used for advertisement enclosures

(75) Inventor: Steven J. DaCunha, West Hartford, CT (US)

Correspondence Address: Pitney Bowes Inc.;Intellectual Property and Technology Law Dept., 35 Waterview Drive, P.O. Box 3000, Shelton, CT, 06484, US

(73) Assignee: Pitney Bowes Incorporated, Stamford, CT (US)

(21) Appl. No.: 10/741,269

(22) Filed: Dec. 19, 2003

(51) Int. Cl. B05D 5/00

(52) U.S. Cl. 427/284

(57) ABSTRACT

An improved method for creating scented advertisement inserts from rectangular sheets for inclusion as inserts into mail pieces. The rectangular sheets have left, right, top and bottom edges. A first step is to apply a scented adhesion to a left strip along the left side of the sheets, and to a right strip along the right side of the sheets. A first fold is made along the left side of the sheets parallel to the left edge, the first fold covering the left strip having the scented adhesion. A second fold is made along the right side of the sheets parallel to the right edge, the second fold covering the right strip having the scented adhesion. After making the first and second folds, the preferred technique is to fold the sheets substantially in half in a direction orthogonal to the first and second folds. Thus the sheets may be easily stacked on one another in preparation for automated feeding as inserts into mail pieces. In this preferred embodiment, the inserts have the same thickness at all four corners, and will tend to stack in a more even and manageable fashion.

### TECHNICAL FIELD

The present invention relates a method for creating folded scented inserts for inclusion in mail pieces created in a high speed mail processing and inserting system.

### BACKGROUND OF THE INVENTION

It is well known in automated mail production systems to include advertising inserts into individualized mail pieces. It is also known that such advertising inserts may include advertisements for perfumes or cologne, and that such advertisements may be comprised of folded sheets that release a sample of advertised scent when the folded portion opened.

Inserter systems such as those applicable for use with the present invention, may include machines such as the 8 series, 9 series, and APS™ inserter systems available from Pitney Bowes Inc. of Stamford Conn.

In many respects, the typical inserter system resembles a manufacturing assembly line. Sheets and other raw materials (other sheets, enclosures, and envelopes) enter the inserter system as inputs. Then, a plurality of different modules or workstations in the inserter system work cooperatively to process the sheets until a finished mail piece is produced. The exact configuration of each inserter system depends upon the needs of each particular customer or installation.

As seen in FIG. 1, a typical inserter system prepares mail pieces by gathering collations 13 of documents on a conveyor 15. Above the conveyor 15, feeders 1 feed documents onto the conveyor to form the collations 13. Feeders 1 hold a stack 10 of inserts. The stack 10 is supported by a guide 11 and a feeding mechanism 12. Further details of an exemplary feeder 1 are provided in co-pending U.S. Patent Application No. 10/004242 filed Oct. 25, 2001, titled REMOVABLE SHEET FEEDER WITH JAM CLEARANCE FOR USE IN AN ENVELOPE INSERTING MACHINE, assigned to the assignee of the present application, which is hereby incorporated by reference in its entirety.

The collations 13 are then transported on the conveyor 15 to an insertion station 16 where they are automatically stuffed into envelopes. After being stuffed with the collations 13, the envelopes are removed from the insertion station 16 for further processing. Such further processing may include automated closing and sealing the envelope flap, weighing the envelope, applying postage to the envelope, and finally sorting and stacking the envelopes.

A prior art method of preparing folded scented inserts is depicted in FIG. 2. Parallel folds 22, at opposite sides of the insert 20, are formed to enclose the scented portions 23. The entire insert 20 is also typically folded in half along fold 21, parallel to the folds 22 for the scented portion. After the insert 20 is folded in half, the portion near fold 21 has a thickness of two times the sheet thickness. However, at the opposite side of insert 20, having the folded scented portions 23, the total thickness of the insert is four times the sheet thickness.

The consequences of one side of the insert 20 being twice as thick as the other are depicted in stack 24 of FIG. 2. When inserts 20 are stacked, the stacking will be uneven, and the side of the stack having the scented portions will tend to be higher. Thus, the stack 24 will be more likely to lean and tip over. A traditional method for solving this problem is to use small stacks 24, or to provide additional framework on feeder 10 to hold up a lopsided stack 24.

### SUMMARY OF THE INVENTION

It has been found that prior art stacks 24 of inserts 20 are difficult to manage, and smaller stacks do not work well with current high speed equipment because they require frequent reloading.

Accordingly, the present invention provides an improved method for creating scented advertisement inserts from rectangular sheets for inclusion as inserts into mail pieces. The rectangular sheets have left, right, top and bottom edges. A first step is to apply a scented adhesion to a left strip along the left side of the sheets and to a right strip along the right side of the sheets. A first fold is made along the left side of the sheets parallel to the left edge. The first fold covers the left strip having the scented adhesion. A second fold is made along the right side of the sheets parallel to the right edge, the second fold covering the right strip having the scented adhesion. After making the first and second folds, the preferred technique is to fold the sheets substantially in half in a direction perpendicular to the first and second folds.

Thus the sheets may be easily stacked on one another in preparation for feeding as inserts into mail pieces. In this embodiment, the inserts have the same thickness at all four corners, and will tend to stack in a more even and manageable fashion. After being stacked the inserts may then be placed in an automated feeding device and can be fed onto collations in an inserting system.

Further details of the present invention are provided in the accompanying drawings, detailed description, and claims.

### BRIEF DESCRIPTION OF THE DRAWINGS

FIG. 1 depicts a system for feeding inserts onto collations for use with the present invention.

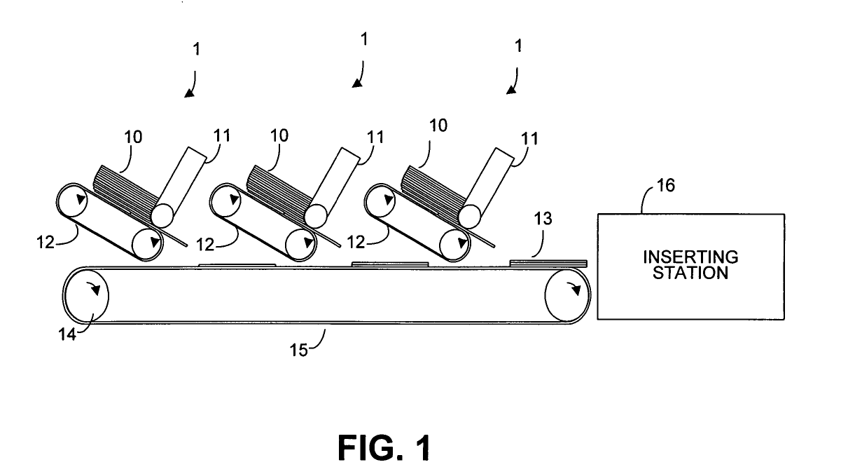

FIG. 2 is a prior art method for preparing folded scented inserts.

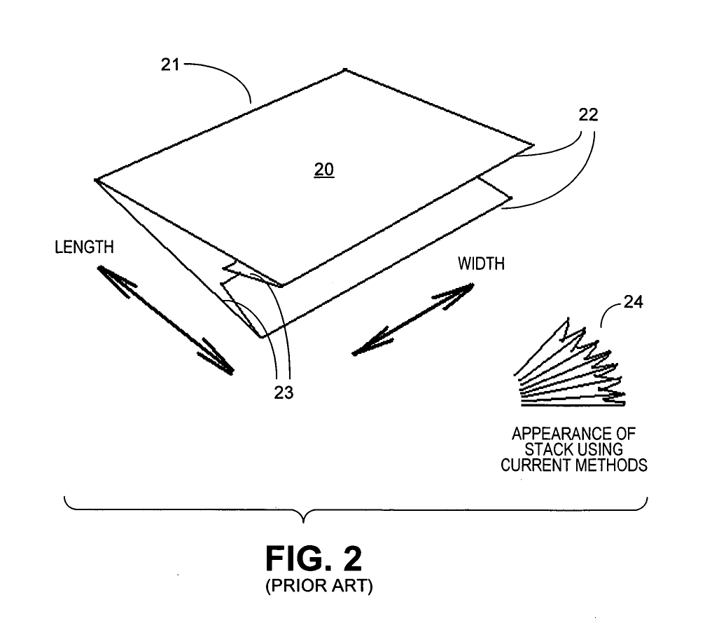

FIG. 3 depicts a preferred embodiment for preparing folded scented inserts in accordance with the present invention.

### DETAILED DESCRIPTION

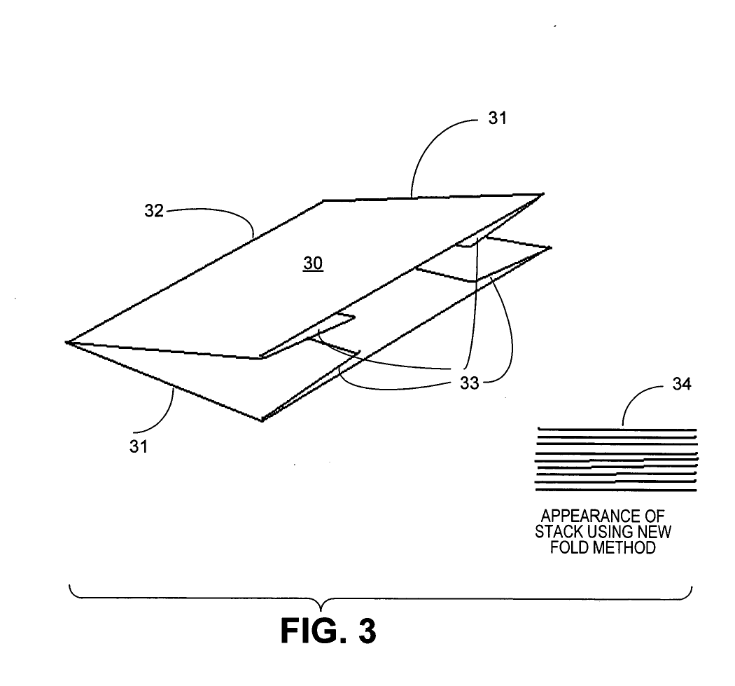

A preferred embodiment for preparing folded scented inserts 30 is depicted in FIG. 3. In the preferred embodiment, two scented portions 33 are created along the left and right portions of the sheet. Strips of scented adhesive material are places on the left and right sides of the sheet using known techniques.

Parallel folds 31 are made from the top to bottom of the sheet 30 to enclose the scented portions 33. After folds 31 are formed on the left and right sides, the sheet 30 is folded in half along fold line 32, perpendicular to the folds 31, and enclosing the scented portions 33. Mechanisms and techniques for making folds 31 and 32 are well known in the art. Exemplary folding techniques may include known buckle-folding and/or knife-folding technology.

After the insert 30 has been folded in half, it may then be stacked in a stack 34 in preparation for placement in an automated feeding device 10. Because stack 34 has the same thickness of four sheets at all four corners, it will tend to stack evenly. Because it stacks evenly, it is more manageable, and larger stacks may be more easily formed, and fed from a high speed feeding device 10.

When stack 34 is placed in an automated feeder 10, guide 11 supports the stack. For optimal feeding, it is preferred that fold 32 be the leading edge as feeding mechanism 12 feeds the bottom insert 30 from the bottom of the stack onto a collation 13 on the conveyor 15 below.

Although the invention has been described with respect to a preferred embodiment thereof, it will be understood by those skilled in the art that the foregoing and various other changes, omissions and deviations in the form and detail thereof may be made without departing from the spirit and scope of this invention.

1. A method for creating scented advertisement inserts from rectangular sheets for inclusion as inserts into mail pieces, the sheets having left, right, top and bottom edges, the method comprising:
applying a scented adhesion to a left strip along the left side of the sheets and to a right strip along the right side of the sheets;
making a first fold along the left side of the sheets parallel to the left edge, the first fold covering the left strip having the scented adhesion;
making a second fold along the right side of the sheets parallel to the right edge, the second fold covering the right strip having the scented adhesion;
after making the first and second folds, folding the sheets substantially in half in a direction orthogonal to the first and second folds; and
stacking the sheets in preparation for feeding as inserts into mail pieces.

2. The method of claim 1 further including the steps of:
inserting the stacked sheets into an automated sheet feeding device; and
automatically feeding individual sheets onto collations of documents passing below on an inserter chassis to form mail pieces having scented advertisement inserts.
